(19) United States
(12) Patent Application Publication
(10) Pub. No.: US 2017/0170884 A1
(43) Pub. Date: Jun. 15, 2017

(54) MU-MIMO SCHEDULER TRANSMIT MODE PROBING WITH TRANSMIT MODE SCORING

(71) Applicant: QUALCOMM Incorporated, San Diego, CA (US)

(72) Inventors: Ahmed Ragab ELSHERIF, Santa Clara, CA (US); Nathaniel David HOUGHTON, San Jose, CA (US); Ehab TAHIR, Mississauga (CA)

(21) Appl. No.: 15/372,267

(22) Filed: Dec. 7, 2016

Related U.S. Application Data
(60) Provisional application No. 62/267,190, filed on Dec. 14, 2015.

(51) Int. Cl. H04B 7/04; H04W 72/04; H04L 27/26

(52) U.S. Cl. CPC H04B 7/0452; H04L 27/26; H04W 72/0406; H04W 88/02

(57) ABSTRACT

In an aspect of the disclosure, a method, a computer-readable medium, and an apparatus are provided. The apparatus may include a processing system configured to determine whether to initiate scheduler probing based on a condition and to perform scheduler probing by determining whether to transmit in SU mode and by determining a set of transmission parameters. The apparatus may include an interface configured to, when the scheduler probing is initiated, output a frame for transmission based on the set of transmission parameters.

### CROSS-REFERENCE TO RELATED APPLICATION(S)

This application claims the benefit of U.S. Provisional Application Ser. No. 62/267,190, entitled “MU-MIMO SCHEDULER TRANSMIT MODE PROBING WITH TRANSMIT MODE SCORING” and filed on Dec. 14, 2015, which is expressly incorporated by reference herein in its entirety.

### BACKGROUND

Field

The present disclosure relates generally to communication systems, and more particularly, to multi-user multiple-input-multiple-output (MU-MIMO) scheduler transmit mode probing with transmit mode scoring.

Background

Communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

As communication networks become increasingly populated by wireless nodes, more efficient methods for transmitting information and reducing interference is needed. The disclosure below describes methods for more efficiently transmitting information and reducing interference.

In an aspect of the disclosure, a method, a computer-readable medium, and an apparatus are provided. The apparatus may include a processing system configured to determine whether to initiate scheduler probing based on a condition, to determine whether to transmit in single-user mode, which may include determining whether to transmit in a specific multi-user mode, for scheduler probing, and to determine a set of transmission parameters for scheduler probing. The apparatus may include an interface configured to output a frame for transmission based on the determination of whether to initiate scheduler probing, the determination of whether to transmit in SU mode, which may include determining whether to transmit in a specific multi-user mode, and the determined set of transmission parameters.

To the accomplishment of the foregoing and related ends, the one or more aspects comprise the features hereinafter fully described and particularly pointed out in the claims. The following description and the annexed drawings set forth in detail contain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a diagram of an example wireless communications network, in accordance with certain aspects of the present disclosure.

FIG. 2 illustrates a block diagram of an example access point (AP) and user terminals (UTs), in accordance with certain aspects of the present disclosure.

FIG. 3 is a diagram that illustrates a problem of stale PER data.

FIG. 4 is a diagram illustrating a method of enhancing MU-MIMO scheduling through transmission mode probing and improved transmission mode scoring.

FIG. 5 shows an example functional block diagram of a wireless device configured to perform MU-MIMO scheduling.

FIG. 6 is a flowchart of an example method of MU-MIMO scheduler enhancement.

FIG. 7 illustrates exemplary means capable of performing the operations set forth in FIG. 6.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

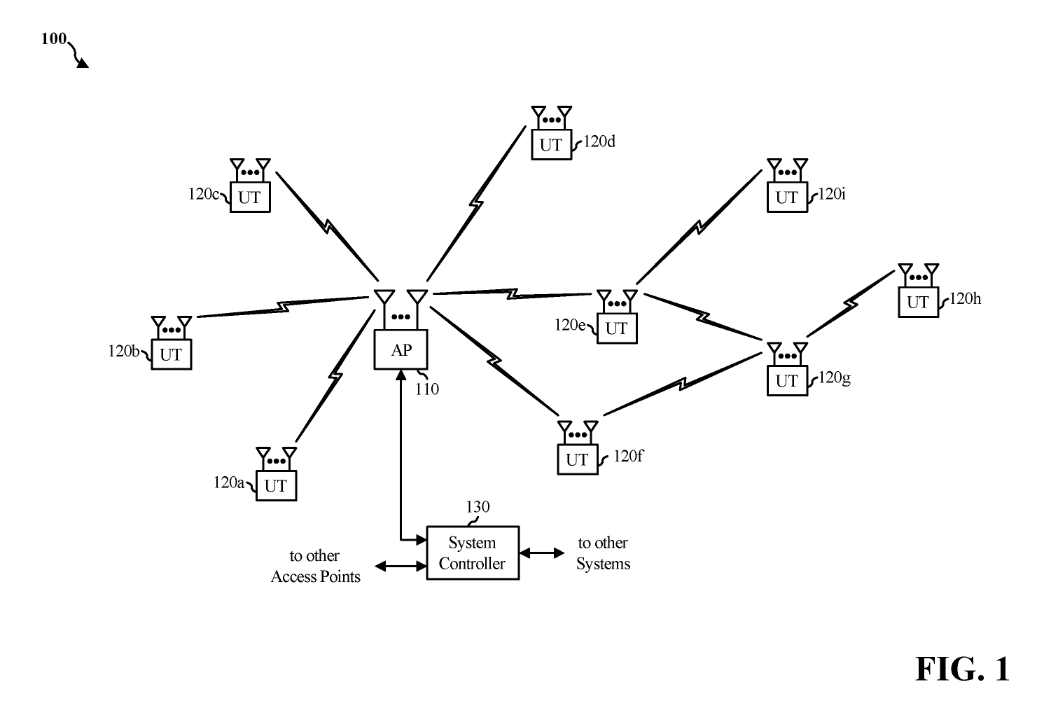

FIG. 1 illustrates a multiple-access multiple-input multiple-output (MIMO) system 100 with access points and user terminals in which aspects of the present disclosure may be practiced. For example, one or more user terminals 120 may signal capabilities (e.g., to access point 110) using the techniques provided herein.

For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless node, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The access point 110 and user terminals 120 employ multiple transmit and multiple receive antennas for data transmission on the downlink and uplink. For downlink MIMO transmissions, Nₐₚ antennas of the access point 110 represent the multiple-input (MI) portion of MIMO, while a set of K user terminals represent the multiple-output (MO) portion of MIMO. Conversely, for uplink MIMO transmissions, the set of K user terminals represent the MI portion, while the Nₐₚ antennas of the access point 110 represent the MO portion. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

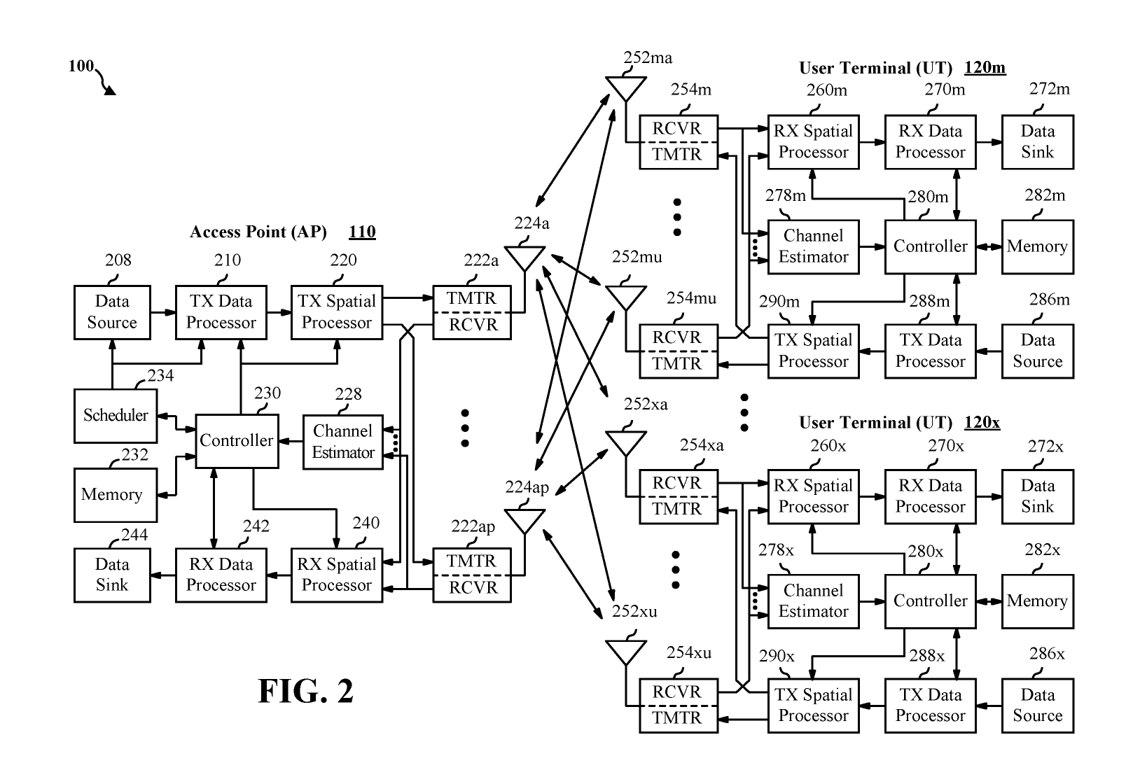

FIG. 2 illustrates a block diagram of access point 110 and two user terminals 120m and 120x in MIMO system 100 that may be examples of the access point 110 and user terminals 120 described above with reference to FIG. 1 and capable of performing the techniques described herein. The various processors shown in FIG. 2 may be configured to perform (or direct a device to perform) various methods described herein.

The access point 110 is equipped with Nₐₚ antennas 224a through 224ap. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink. For SDMA transmissions, Nᵤₚ user terminals simultaneously transmit on the uplink, while Nan user terminals are simultaneously transmitted to on the downlink by the access point 110. Nᵤₚ may or may not be equal to Nan, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal. The decoded data for each user terminal may be provided to a data sink 272 for storage and/or a controller 280 for further processing.

At each user terminal 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

In MIMO systems similar to the one shown in FIG. 1, channel conditions may change over time and devices within the system may be required to adapt to interference and other conditions that may adversely affect data transmissions. In an aspect, when a wireless device is engaged in MU-MIMO transmissions, a MU-MIMO scheduler in the wireless device may consider the supported modulation and coding schemes (MCSs) of each user in an MU group to which the wireless device will transmit and the sounding overhead associated with forming such a group in choosing parameters for data transmission. The parameters may include, for example, an MCS, a number of spatial streams, and a transmission bandwidth, among others. The MCS value or index fed into the MU-MIMO scheduler may be recommended by a rate adaptation component in the wireless device based on a packet error rate (PER) history for each MCS, a number of spatial streams (Nss), and a bandwidth combination for each user in MU mode. In an aspect, the MU-MIMO scheduler and the rate adaptation component may be implemented in separate components or a single component within the wireless device.

The PER data is important for determining the optimal transmission parameters. PER data may become stale, if not frequently updated, or incomplete, if insufficient transmission parameters have been attempted to determine the PER associated with various transmission parameters. When a wireless device does not attempt a variety of transmit modes (e.g., single user, MU2 (2 MU users), MU3 (3 MU users), or other MU modes), the rate adaptation component may not have accurate PER data to make a proper MCS recommendation, which may result in the scheduler component missing opportunities for better throughput. Further, a scheduler may select a transmission mode, such as SU, MU2, MU3, or other modes, based on scoring metrics. Scoring metrics that attempt to maximize medium access control (MAC) efficiency ignore the actual throughput that could be obtained for various transmit modes (SU, MU2, MU3, etc.) As such, a need exists to avoid stale or incomplete PER data and to improve methods for computing scoring metrics.

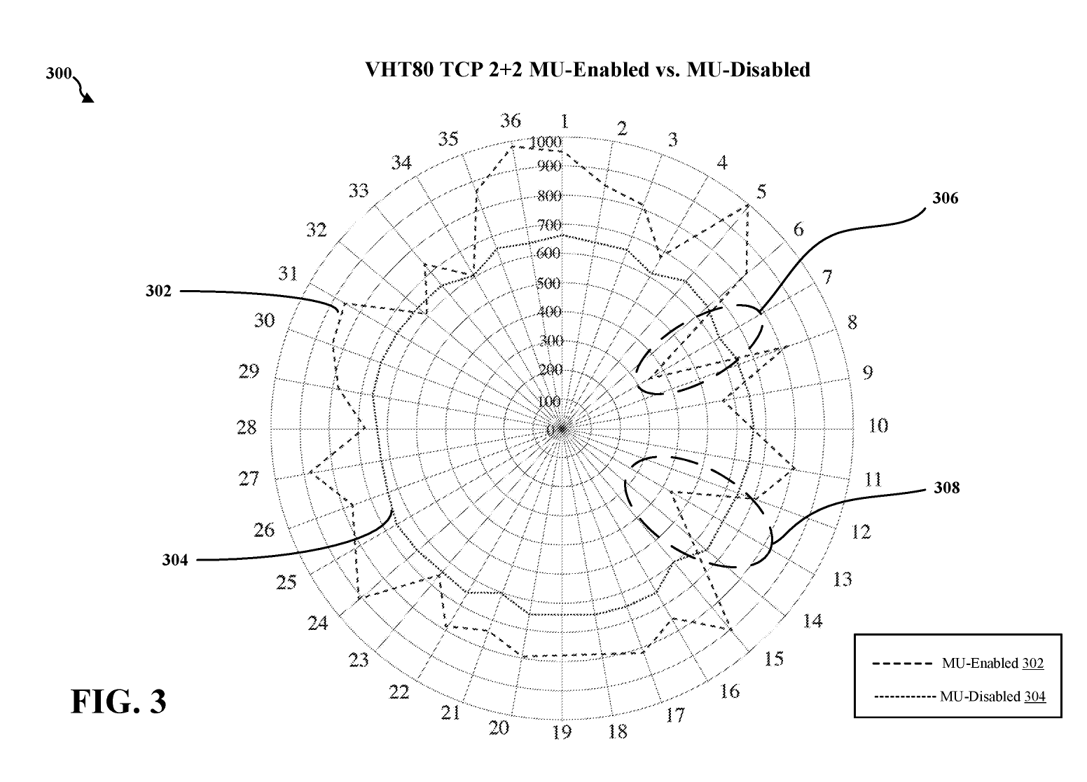

FIG. 3 is a diagram 300 that illustrates a problem of stale and incomplete PER data. FIG. 3 shows two curves that depict the data throughput of an AP (or another wireless device) in megabits per second (Mbps). The distal values from the center of the circle represent data throughput of the AP (e.g., from 0-1000 Mbps). The radial values, 1-36, represent a relative angle of orientation between the AP and a STA (or another wireless device) receiving the data transmission from the AP. For example, at radial value 1, the AP may be rotated 10 degrees away from the STA, and at radial value 8, the AP may be rotated 80 degrees away from the STA.

A first curve 302 is associated with the data throughput of the AP when MU is enabled at the AP (e.g., MU-MIMO mode), and a second curve 304 is associated with the data throughput of the AP when MU is disabled (e.g., SU mode). In an aspect, the MU-enabled may be for MU2+2 (AP transmits to 2 users, each user with 2 spatial streams) or MU2+1+1 (AP transmits to 3 users, 1 user with 2 spatial streams and the remaining 2 users with 1 spatial stream each). As shown in FIG. 3, in most instances, the first curve 302 shows that throughput for an MU-enabled transmission mode is approximately equal to or better than an MU-disabled transmission mode as shown by the second curve 304 except in a first region 306 and a second region 308. In the first and second regions 306, 308 the MU-enabled transmission mode has worse throughput than the MU-disabled transmission mode (or SU transmission mode), which may not be accepted. As shown by FIG. 3, the MU-enabled transmission mode, as shown by the MU 4 spatial stream test case in FIG. 3, is sensitive to channel correlation, and therefore, at some orientations, the MU2+2 mode may have a lower MCS (e.g., MCS 5) when compared to an SU transmission mode with 2 spatial streams at MCS 9.

The rate adaptation component, however, may not have tried MCS 9 for SU mode if the rate adaptation component assumes that the throughput in MU-enabled mode is always greater than the throughput in SU mode. The failure to attempt SU transmission would provide an inaccurate MCS recommendation and transmission mode. Instead, the rate adaptation component may remain in MU mode and attempt a lower MU MCS for transmission. Alternatively, the scheduler may be comparing SU, with 2 spatial streams at MCS 5, against MU2+2 at MCS 5 and choose the MU mode, which may result in MU transmissions having lower throughput than SU transmissions at MCS 9 (e.g., MU gain<1). While MU mode performance should, in general, be lower bounded by SU mode performance, a need exists to enable wireless devices to switch to the SU transmission mode if the MU transmission mode is worse than the SU transmission mode at some orientations.

In addition to stale PER data, another shortcoming relates to scoring metric deficiencies. As previously indicated, current scoring metrics attempt to maximize MAC efficiency while ignoring actual throughput that would be obtained for various transmission modes. Current scoring metrics may be calculated based on the Eq. 1:

$$score\_m = mac\_efficiency \_m = {\sum }_{n = 1}^{N} \frac{ppdu\_data \_tx \_time \_m \_n}{tx\_air \_time \_m}$$

Referring to Eq. 1, N corresponds to the total number of users for transmission (e.g., 3 users in MU3), n corresponds to a user index for each user (e.g., 1, 2, 3 if there are 3 users), and m corresponds to a transmission mode (e.g., SU, MU2, MU3, or MU−N, where N is equal to a number of users in the MU group). The score_m corresponds to the MAC efficiency for a particular transmission mode m, tx_air_time_m corresponds to a total transmission air time for the transmission mode, which may be equal to the total amount of time consumed on the wireless medium including actual data transmission and associated overhead time. The ppdu_data_tx_time_m_n corresponds to a total amount of time to transmit an amount of user data based on a transmission physical layer (TX PHY rate). In an aspect, tx_air_time_m may be calculated based on Eq. 2:

tx_air_time_m=max_n(ppdu_data_tx_time_m_n)+tx_overhead_time_m

As shown in Eq. 2, tx_air_time_m, the total transmission air time for the transmission mode (e.g., measured in seconds or milliseconds) may be a sum of a maximum ppdu_data_tx_time_m_n, which correspond to a physical layer convergence procedure (PLCP) protocol data unit (PPDU) data transmit time (e.g., an amount of time to transmit a PPDU such as 8 ms) and a tx_overhead_time_m. In an aspect, ppdu_data_tx_time_m_n may be the amount of user data that may be transmitted during a transmit opportunity divided by the TX PHY rate for user n. The TX PHY rate may be based on historical transmission results at the transmitting device. In another aspect, the TX PHY rate may be a rate recommended by a rate control component within the transmitting device. In one aspect, the ppdu_data_tx_time_m_n may be different for each transmission mode m and for each user n. In another aspect, the ppdu_data_tx_time_m_n may be capped by an amount of queued data actually available for users being transmitted to and by the maximum amount of time that may be spent on a particular transmission (e.g., a transmission opportunity duration). Because each user's TX data time may be different, max_n(ppdu_data_tx_time_m_n) is the maximum transmission air time among users in transmission mode m. That is, the function max_n( ) picks the user with index n that maximizes the amount between the parentheses.

The tx_overhead_time_m may correspond to a total amount of overhead time for signaling set up during a transmission. In an aspect, the tx_overhead_time_m may be measured in seconds or milliseconds. The tx_overhead_time_m may include time associated with sounding overhead, gaining access to the medium, and/or transmission padding. The tx_overhead_time_m may be a function of the transmission mode m because each transmission mode may have different transmission overheads. For example, an SU transmission mode may have less overhead than an MU transmission mode, and an MU transmission mode with more users may have more sounding procedures than an MU transmission mode with less users. Referring to Eq. 1, there may be a score for different transmission modes, such as score_SU, score_MU2, and score_MU3. The transmission mode corresponding to the highest score may be used for transmission.

However, Eq. 1 considers the physical layer throughput only for calculating ppdu_data_tx_time_m, and as a result, the highest score mode will not necessarily have the highest data throughout, only the highest MAC efficiency. As such, a need exists for recalibrating the scoring metric calculations in order to consider transmission modes that provide the highest data throughput.

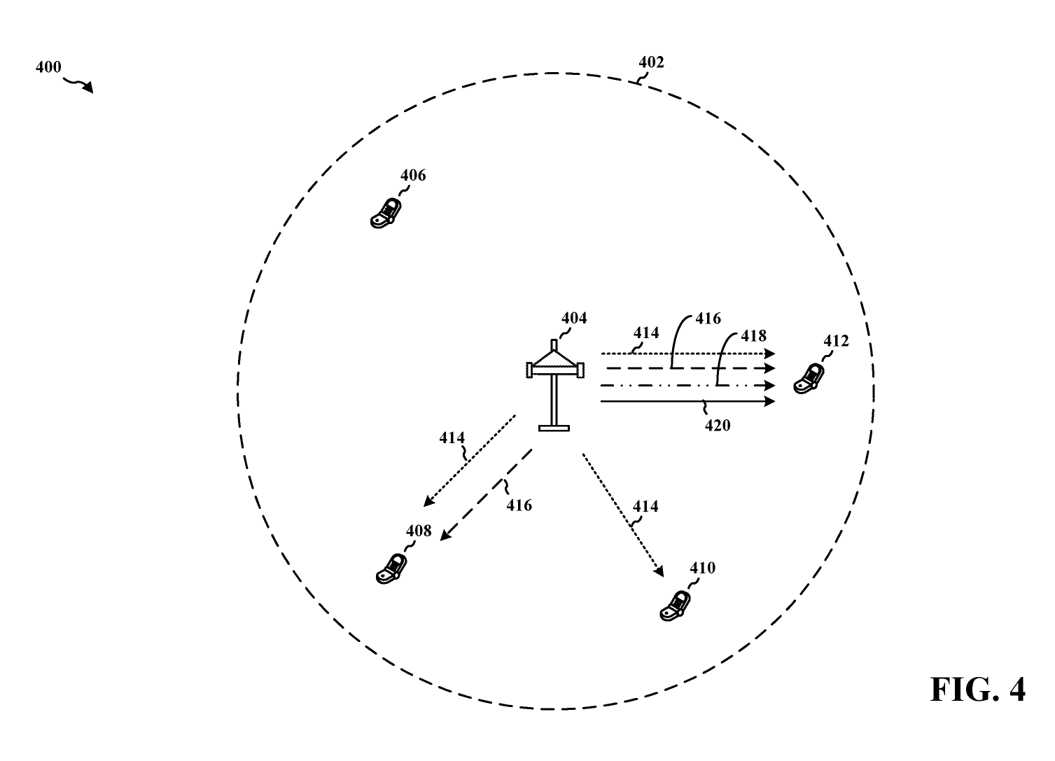

FIG. 4 is a diagram 400 illustrating a method of enhancing MU-MIMO scheduling through transmission mode probing and improved transmission mode scoring. Referring to FIG. 4, a BSS 402 may include an AP 404 serving a first STA 406, a second STA 408, a third STA 410, and a fourth STA 412. In an aspect, the AP 404 may be in an MU2+1+1 transmission mode with the second, third, and fourth STAs 408, 410, 412. For example, the AP 404 may send a first transmission 414 (or set of transmissions) in MU3 transmission mode. In MU3 mode, the 2 spatial streams may be allocated to the second STA 408, 1 spatial stream may be allocated to the third STA 410, and 1 spatial stream may be allocated to the fourth STA 412.

Based on feedback from the first transmission 414, the AP 404 may determine that a scheduler probing condition (e.g., of a set of scheduler probing conditions) has been triggered. In one aspect, the scheduler probing condition may indicate that when a recommended MCS drops below an MU MCS threshold (e.g., MCS 6 or another MCS index), the AP 404 is to perform scheduler probing to determine whether other transmission parameters may increase throughput. The recommended MCS may be from a rate adaptation component of the AP 404, which may recommend an MCS based on PER data stored in the AP 404. Alternatively, if the AP 404 was transmitting in SU mode, another scheduler probing condition may indicate that when a recommended MCS increases above a SU MCS threshold to initiate scheduler probing. In another aspect, the scheduler probing condition may indicate that the AP 404 may initiate scheduler probing when a scheduler probing time duration or timer has expired. The scheduler probing period may be dynamic. For example, the scheduler probing period may be 200 ms, and if probing results in a worse mode or worse transmission parameters being selected (e.g., lower throughput), then the scheduler probing period may be increased (e.g., 300 ms). If probing resulted in better results (e.g., increased throughput), then the scheduler probing period may be decreased. In an aspect, the AP 404 may set a minimum and/or maximum schedule probing period.

In one configuration, when probing down from an MU mode, the AP 404 may probe down one step at a time. For example, if a current MU mode is MU3, the AP 404 may probe down to MU2. If MU2 does not improve throughput above a threshold, then at the start of the next probing period, the AP 404 may probe down to SU mode. Similarly, when probing up from an SU or an MU mode, the AP 404 may probe up one step at a time. For example, if a current mode is SU, the AP 404 may probe up to MU2. If MU2 improves throughput above a threshold, then at the start of the next probing period, the AP 404 may probe up to MU3 mode.

For example, referring to FIG. 4, the AP 404 may initially be in MU3 (e.g., MU2+1+1). Having determined that the recommended MU MCS based on PER data is below MCS 6, the AP 404 may determine that a scheduler probing condition has been triggered. Based on the triggered condition, the AP 404 may determine to initiate scheduler probing. In an aspect, the AP 404 may determine whether to transmit in SU mode for scheduler probing. Because the AP 404 is in MU3 mode, however, the AP 404 may probe down one step at a time, and attempt to transmit in MU2 mode instead of going straight to SU mode. Specifically, the AP 404 may select the second and fourth STAs 408, 412 to which to transmit in MU2 mode. The AP 404 may determine a first set of transmission parameters to transmit a second transmission 416 (e.g., a frame) in MU2 mode. For example, the AP 404 may determine the first set of transmission parameters by determining a recommended MU2 MCS (e.g., MCS 8 for MU2 mode), a number of spatial streams, and/or a bandwidth to transmit the second transmission 416. The AP 404 may determine a number of MAC data protocol units (MPDUs) to include in the second transmission 416 for scheduler probing. The second transmission 416 may be a probing frame or any other frame. In one aspect, the size of the second transmission 416 may be limited (e.g., 4 MPDUs) in case the probing transmission is unsuccessful. In another aspect, the AP 404 may avoid bursting for the second transmission 416 (e.g., by transmitting 1 PPDU).

After the second transmission 416, the AP 404 may obtain feedback from the second and fourth STAs 408, 412. Based on the obtained feedback, the AP 404 may update the PER associated with the MU2 mode, MCS, number of spatial streams, and bandwidth used to transmit the second transmission 416. If the feedback indicates that the scheduler probing was unsuccessful (e.g., an updated PER above a threshold), the AP 404 may increase the scheduler probing period (e.g., from 200 ms to 300 ms). The scheduler probing period may be increased rather than decreased when the probing is unsuccessful to prevent additional loss in throughput by transmitting in less than ideal parameters. By contrast, scheduler probing period may be decreased when the probing is successful because increased probing due to the shortened period may not result in reduced throughput if the transmission parameters result in good throughput.

At the beginning of the next scheduler probing period (or once the scheduler probing timer expires), the AP 404 may determine to perform scheduler probing. Based on a previous probing transmission mode and/or a previous MCS, the AP 404 may determine whether to transmit in SU mode. In this case, because the previous probing transmission mode was MU2, and the feedback indicated that the PER for MU2 transmission was high, the AP 404 may determine to probe down one step and transmit in SU mode. The AP 404 may transmit in SU mode with the fourth STA 412. The AP 404 may determine a set of transmission parameters for transmitting a frame in SU mode to the fourth STA 412 via a third transmission 418. For example, the AP 404 may determine to transmit 4 MPDUs at MCS 9 in SU mode with 2 spatial streams, and at a particular bandwidth. Based on the second probing attempt, the AP 404 may receive feedback from the fourth STA 412. The feedback may indicate a low PER for SU mode transmissions at MCS 9. The AP 404 may update the PER associated with SU at MCS 9 using 2 spatial streams.

By performing scheduler probing at different transmission modes and at different MCSs (including higher MCSs for SU mode than for MU mode), the AP 404 may build a more complete database or table of PER data. In an aspect, the AP 404 may ensure MU-mode PER monotonicity in the rate adaptation rate and/or PER table. In this aspect, at the same MCS/Nss/BW, the AP 404 may maintain the following condition: PER_{SU}≦PER_{MU2}≦PER_{MU3}. That is, when the AP 404 updates the PER entry for a specific SU-mode or MU-mode, the AP 404 may ensure monotonicity for other modes. For example, if the feedback from the scheduler probing indicates that PER_{MU2} is greater than PER_{MU3}, then the AP 404 may increase the stored value of PER_{MU3} (e.g., make PER_{MU3} equal to PER_{MU2}) to preserve the condition that PER_{MU2} is less than or equal to PER_{MU3}.

With a more updated and complete PER database/table, the AP 404 may determine a transmission mode for transmitting data. For example, based on the PER table, the rate adaptation component in the AP 404 may provide the scheduler in the AP 404 with an MCS for various transmission modes such as SU, MU2, MU3, or others. Based on the MCSs, the AP 404 may determine a transmission mode for transmitting the data. In one configuration, the AP 404 may determine the transmission mode by calculating a set of scoring metrics associated with the throughput of each of the transmission modes. The throughput scoring metrics may be calculated based on Eq. 3:

$$score\_m = throughput\_m = {\sum }_{n = 1}^{N} \frac{user\_tx \_data \_bytes \_m \_n}{tx\_air \_time \_m}$$

Referring to Eq. 3, N corresponds to the total number of users for transmission, n corresponds to a user index for each user (e.g., 1, 2, 3 if there are 3 users), and m corresponds to a transmission mode (e.g., SU, MU2, MU3, or MU−N, where N is equal to a number of users in the MU group). The score_m, which may be measured in bits per second, corresponds to the calculated throughput for a particular transmission mode m, tx_air_time_m, which may be measured in milliseconds or seconds, corresponds to a total transmission air time for the transmission mode, such as the total amount of time consumed on the wireless medium including actual data transmission and associated overhead time, and the user_tx_data_bytes_m_n corresponds to a total amount of data bits that will be transmitted during a transmit opportunity (TXOP) for a particular user n and transmission mode m. In an aspect, tx_air_time_m may be calculated based on Eq. 2:

tx_air_time_m=max_n(ppdu_data_tx_time_m_n)+tx_overhead_time_m

As shown in Eq. 2, tx_air_time_m, the total transmission air time for the transmission mode (e.g., measured in seconds or milliseconds) may be a sum of a maximum ppdu_data_tx_time_m_n, which correspond to a PPDU data transmit time (e.g., an amount of time to transmit a PPDU such as 8 ms) and a tx_overhead_time_m. In an aspect, ppdu_data_tx_time_m_n may be the amount of user data that may be transmitted during a transmit opportunity divided by the TX PHY rate for user n. The TX PHY rate may be based on historical transmission results at the transmitting device. In another aspect, the TX PHY rate may be a rate recommended by a rate control module within the transmitting device. In one aspect, the ppdu_data_tx_time_m_n may be different for each transmission mode m and for each user n. In another aspect, the ppdu_data_tx_time_m_n may be capped by an amount of queued data actually available for users being transmitted to and by the maximum amount of time that may be spent on a particular transmission (e.g., a transmission opportunity duration). Because each user's TX data time may be different, max_n(ppdu_data_tx_time_m_n) is the maximum transmission air time among n users. The tx_overhead_time_m may correspond to a total amount of overhead time for signaling set up during a transmission. In an aspect, the tx_overhead_time_m may be measured in seconds or milliseconds. The tx_overhead_time_m may include time associated with sounding overhead, gaining access to the medium, and transmission padding. The tx_overhead_time_m may be a function of the transmission mode m because each transmission mode may have different transmission overheads. For example, an SU transmission mode may have less overhead than an MU transmission mode, and an MU transmission mode with more users may have more sounding procedures than an MU transmission mode with less users.

The total amount of data bits that will be transmitted, user_tx_data_bytes_m_n, may be calculated based on Eq. 4:

user_tx_data_bits_m_n=ppdu_data_tx_time_m_n*tx_data_rate_m_n

Referring to Eq. 4, tx_data_rate_m_n may be the expected achievable throughput that may be obtained during the transmission (or TXOP). The tx_data_rate_m_n may be determined based on Eq. 5:

tx_data_rate_m_n=tx_PHY_rate_m_n*(1−PER_m_n)

Referring to Eq. 5, tx_data_rate_m_n is a function of the TX PHY rate associated with a particular user n at a transmission mode m (tx_PHY_rate_m_n) as well as the historical packet error rate for user n at transmission mode m (PER_m_n). In an aspect, the tx_data_rate_m_n may be measured in units of bits per second.

Returning to Eq. 3, the score_m takes into consideration the sounding and transmission overheads as well as the actual amount of data that may be transmitted during a transmission opportunity due to the transmission PHY rate. The score_m may be a separate score for different transmission modes, such as score_SU, score_MU2, and score_MU3, and may be measured in units of bits per second. The AP 404 may select the transmission mode corresponding to the highest score to use for data transmission for optimizing throughput.

Referring to FIG. 4, the AP 404 may determine that score_SU is greater than score_MU2 and score_MU3. Accordingly, the AP 404 may determine to transmit in SU mode to the fourth STA 412. The AP 404 may transmit one or more frames in a fourth transmission 420 to the fourth STA 412 in SU mode.

Although the above disclosure describes the AP 404 as using MU-MIMO scheduler enhancement, the methods, techniques, and protocols described herein are not limited to an AP and may be used by any wireless device for downlink or uplink transmission. Further, although the above disclosure describes scheduler probing as probing down, scheduler probing may include probing up. For example, while in SU mode, if the AP 404 is recommended to use an SU MCS of 7 or greater, then the AP 404 may probe up at different MU transmission modes to determine if greater throughput may be achieved.

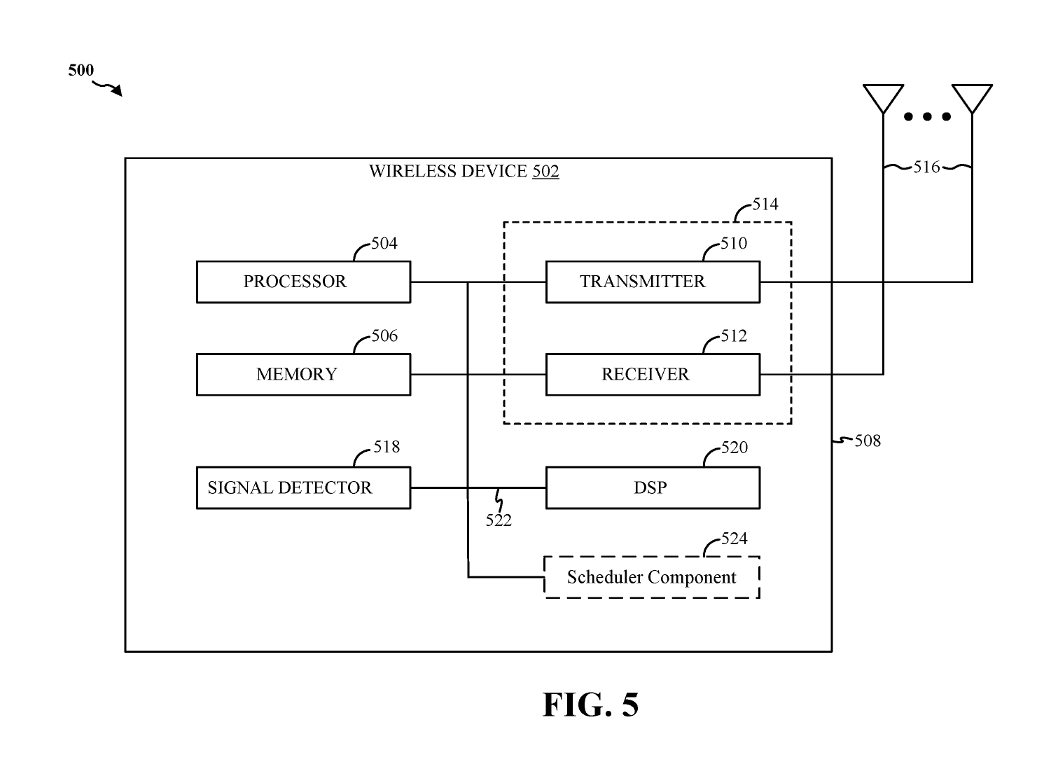

FIG. 5 shows an example functional block diagram of a wireless device 502 configured to perform MU-MIMO scheduling. The wireless device 502 is an example of a device that may be configured to implement the various methods described herein. For example, the wireless device 502 may be the AP 110 and/or the user terminal 120.

The wireless device 502 may include a processor 504 which controls operation of the wireless device 502. The processor 504 may also be referred to as a central processing unit (CPU). Memory 506, which may include both read-only memory (ROM) and random access memory (RAM), may provide instructions and data to the processor 504. A portion of the memory 506 may also include non-volatile random access memory (NVRAM). The processor 504 typically performs logical and arithmetic operations based on program instructions stored within the memory 506. The instructions in the memory 506 may be executable (by the processor 504, for example) to implement the methods described herein.

The wireless device 502 may also include a housing 508, and the wireless device 502 may include a transmitter 510 and a receiver 512 to allow transmission and reception of data between the wireless device 502 and a remote device. The transmitter 510 and receiver 512 may be combined into a transceiver 514. A single transmit antenna or a plurality of transmit antennas 516 may be attached to the housing 508 and electrically coupled to the transceiver 514. The wireless device 502 may also include multiple transmitters, multiple receivers, and multiple transceivers.

The wireless device 502 may also include a signal detector 518 that may be used in an effort to detect and quantify the level of signals received by the transceiver 514 or the receiver 512. The signal detector 518 may detect such signals as total energy, energy per subcarrier per symbol, power spectral density and other signals. The wireless device 502 may also include a digital signal processor (DSP) 520 for use in processing signals. The DSP 520 may be configured to generate a packet for transmission. In some aspects, the packet may comprise a PPDU.

The various components of the wireless device 502 may be coupled together by a bus system 522, which may include a power bus, a control signal bus, and a status signal bus in addition to a data bus. In one configuration, when the wireless device 502 is implemented as an AP or a STA configured to transmit data on a data channel, the wireless device 502 may include a scheduler component 524. The scheduler component 524 may be configured to determine whether to initiate scheduler probing based on a condition. The scheduler component 524 may be configured to determine whether to transmit in SU mode for scheduler probing and to determine a set of transmission parameters for scheduler probing. The scheduler component 524 may be configured to output a frame for transmission based on the determination of whether to initiate scheduler probing, the determination of whether to transmit in SU mode, and the determined set of transmission parameters. In another configuration, the scheduler component 524 may be configured to determine whether to initiate scheduler probing by performing at least one of determining an MU MCS, determining a SU MCS, or determining whether a scheduler probing period has expired. In this configuration, the condition is one of the determined MU MCS being less than or equal to a first threshold, the determined SU MCS being greater than or equal to a second threshold, or the scheduler probing period having expired. In another configuration, the determination of whether to transmit in SU mode for scheduler probing may be based on a previously probed transmission mode or a previously probed MCS. In another configuration, the scheduler component 524 may be configured to determine the set of transmission parameters by determining at least one of an MCS, a number of spatial streams, or a bandwidth to use for transmitting the frame for scheduler probing or by determining a number of data units to transmit within the frame for scheduler probing. In another configuration, the scheduler component 524 may be configured to obtain feedback based on the outputted frame and to update PER information based on the obtained feedback. The PER information may be associated with the determined set of transmission parameters used to transmit the frame. In another configuration, the scheduler component 524 may be configured to adjust a scheduler probing period based on the obtained feedback. The scheduler probing may be performed based on the adjusted scheduler probing period. In another configuration, the scheduler component 524 may be configured to determine a transmission mode for transmitting data by calculating a set of scoring metrics associated with one or more transmission modes and by selecting the transmission mode associated with a highest scoring metric for throughput within the set of scoring metrics. In an aspect, each scoring metric in the set of scoring metrics may be a throughput measurement associated with a particular transmission mode, and each scoring metric may be calculated based on a total transmission airtime and a total amount of data to be transmitted for each user of a number of devices associated with the particular transmission mode. In an aspect, the above operations may also be performed by the processor 504.

In general, an AP and STA may perform similar (e.g., symmetric or complementary) operations. Therefore, for many of the techniques described herein, an AP or STA may perform similar operations. To that end, the following description will sometimes refer to an “AP/STA” to reflect that an operation may be performed by either. Although, it should be understood that even if only “AP” or “STA” is used, it does not mean a corresponding operation or mechanism is limited to that type of device.

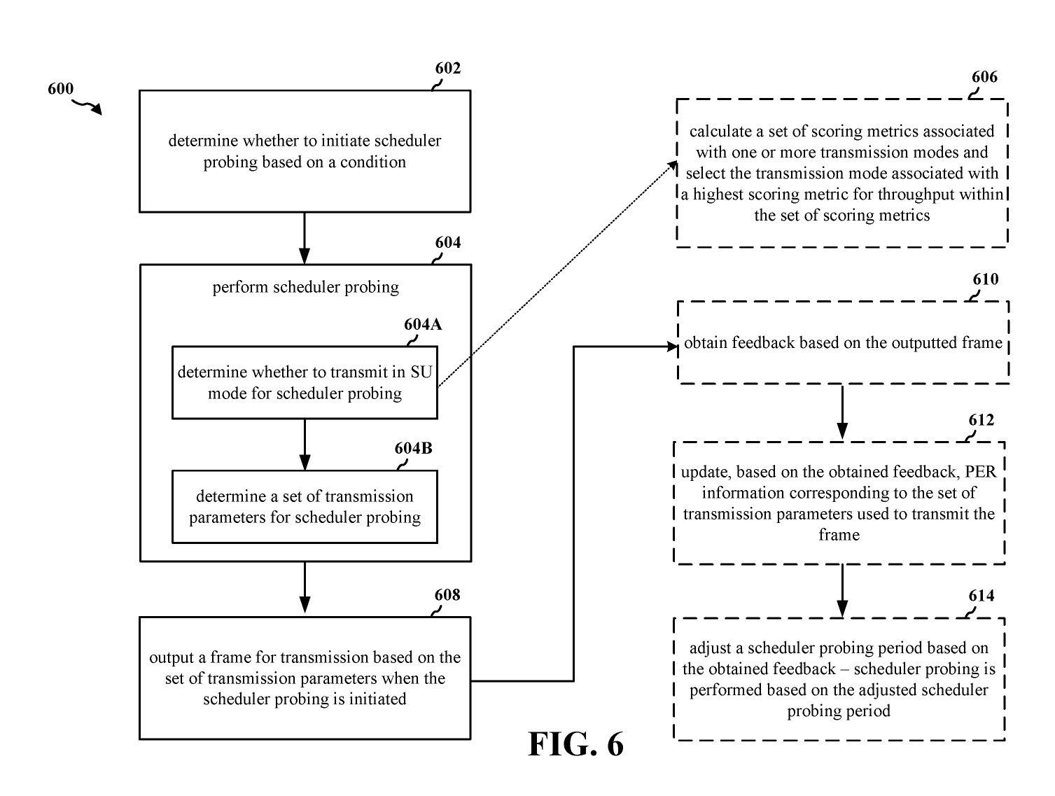

FIG. 6 is a flowchart of an example method 600 of MU-MIMO scheduler enhancement. The method 600 may be performed using an apparatus (e.g., the AP 110, the user terminal 120, or the wireless device 502, for example). Although the method 600 is described below with respect to the elements of wireless device 502 of FIG. 5, other components may be used to implement one or more of the steps described herein. Blocks denoted by dotted lines may represent optional operations.

At block 602, an apparatus may determine whether to initiate scheduler probing based on a condition. In one configuration, the apparatus may determine whether to initiate by determining an MU MCS, determining a SU MCS, or determining whether a scheduler probing period has expired. In this configuration, the condition may be one of the determined MU MCS being less than or equal to a first threshold (e.g., an MU MCS threshold), the determined SU MCS being greater than or equal to a second threshold (e.g., a SU MCS threshold), or the scheduler probing period having expired. For example, referring to FIG. 4, the apparatus may correspond to the AP 404. The AP 404 may determine that the MU MCS is less than MCS 6. Based on this determination, the AP 404 may determine to initiate scheduler probing.

At block 604, the apparatus may perform scheduler probing. In an aspect, the apparatus may performs scheduler probing by determining whether to transmit in SU mode for scheduler probing (at 604A) and by determining a set of transmission parameters for scheduler probing (at 604B). In one configuration, the determination of whether to transmit in SU mode for scheduler probing may be based on a previously probed transmission mode and/or a previously probed MCS. In an aspect, the apparatus may determine whether to transmit in SU mode by determining to probe down to the SU mode from an MU mode, determining to probe down from a current MU mode (e.g., MU3 mode) to a lower order MU mode (e.g., MU2 mode), determining to probe up from the SU mode to the MU mode, determining to probe up from the current MU mode (e.g., MU2 mode) to a higher order MU mode (e.g., MU3 mode). In one example, referring to FIG. 4, the AP 404 may determine that a previously probed transmission mode was MU3, and therefore, based on a stepwise approach, the AP 404 may determine to transmit in MU2 mode instead of SU mode. In another example, the AP 404 may determine that a previously probed transmission mode was MU2, and therefore, the AP 404 may determine to transmit in SU mode. In another example, the AP 404 may not follow the stepwise approach and may determine that the AP 404 had previously probed in MU3 mode at MCS 4, and therefore, the AP 404 may determine to transmit in SU mode. In another example, the AP 404 may determine that a 200 ms probing timer has expired, and the AP 404 may determine to initiate scheduler probing.

In one configuration, at 606, the apparatus may determine whether to transmit in SU mode by calculating a set of scoring metrics associated with one or more transmission modes and by selecting the transmission mode with a highest scoring metric for throughput within the set of scoring metrics. In aspect, each scoring metric in the set of scoring metrics is a throughput measurement associated with a particular transmission mode, and each scoring metric is calculated based on a total transmission airtime and a total amount of data to be transmitted for each user of a number of devices associated with the particular transmission mode. For example, referring to FIG. 4, the AP 404 may determine to transmit in SU mode for transmitting data to the fourth STA 412 in the fourth transmission 420 by calculating the throughput scoring metrics for SU, MU2, and MU3 using Eq. 3 and determining that the throughput scoring metric for SU is higher than the other modes.

The apparatus may be configured to determine the set of transmission parameters by determining at least one of an MCS, a number of spatial streams, or a bandwidth to use for transmitting the frame for scheduler probing and by determining a number of data units to transmit within the frame for scheduler probing. For example, referring to FIG. 4, the AP 404 may determine to use MCS 8 in MU2 mode with the second and fourth STAs 408, 412, such that each STA has 2 spatial streams each. The AP 404 may determine to transmit 4 MPDUs within the frame for scheduler probing.

At block 608, the apparatus may output a frame for transmission based on the set of transmission parameters. For example, referring to FIG. 4, the AP 404 may output the frame that is sent in the second transmission 416 to the second and fourth STAs 408, 412 for scheduler probing based on the determination to initiate scheduler probing, the determination not to transmit in SU mode (but rather in MU2 mode), and the determined set of transmission parameters.

At block 610, the apparatus may obtain feedback based on the outputted frame. For example, referring to FIG. 4, based on the second transmission 416, the AP 404 may obtain feedback from the second and the fourth STAs 408, 412 based on the outputted frame sent in the second transmission 416. The feedback may indicate acknowledgment information associated with the second transmission 416 and/or PER information associated with the second transmission 416.

At block 612, the apparatus may update, based on the obtained feedback, PER information corresponding to the determined set of transmission parameters. For example, referring to FIG. 3, the AP 404 may update PER information based on the obtained feedback. The PER information may be associated with the determined set of transmission parameters used to transmit the frame in the second transmission 416. In an aspect, if existing information related to the transmission parameters is available, then the existing information may be replaced with the more updated PER information. Otherwise, if existing information is not available, then the AP 404 may update the PER information by storing the newly obtained PER information.

At block 614, the apparatus may adjust a scheduler probing period based on the obtained feedback, and scheduler probing may be performed based on the adjusted scheduler probing period. For example, referring to FIG. 4, the AP 404 may adjust the scheduler probing period from 200 ms to 300 ms if the obtained feedback indicates that the PER is greater than or equal to a PER threshold. In another example, the AP 404 may adjust the scheduler probing period from 200 ms to 100 ms if the obtained feedback indicates that the PER is less than or equal to a PER threshold.

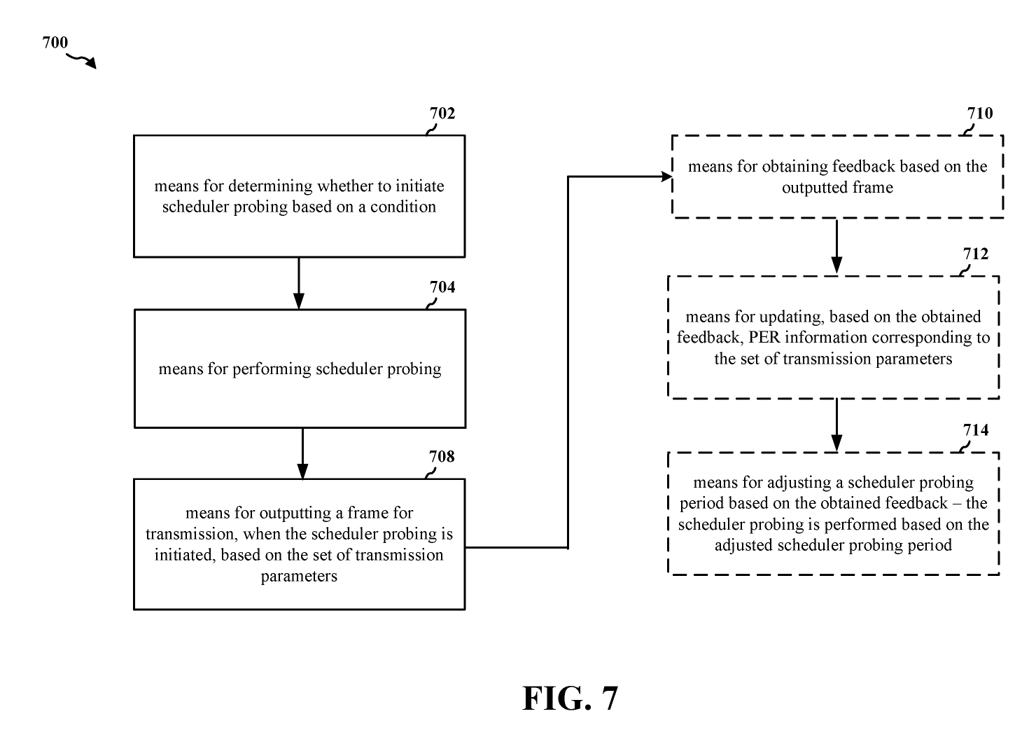

FIG. 7 illustrates exemplary means 700 capable of performing the operations set forth in FIG. 6. The exemplary means 700 may include means 702 for determining whether to initiate scheduler probing based on a condition. Means 702 may include, for example, transmitter units 222, transmitter units 254, TX spatial processor 220, TX spatial processors 290, TX data processor 210, TX data processors 288, controller 230, controllers 280, antennas 516, transmitter 510, digital signal processor 520, and/or processor 504 shown in FIG. 2 and FIG. 5. The exemplary means 700 may include means 704 for performing scheduler probing. Means 704 may include, for example, transmitter units 222, transmitter units 254, TX spatial processor 220, TX spatial processors 290, TX data processor 210, TX data processors 288, controller 230, controllers 280, antennas 516, transmitter 510, digital signal processor 520, and/or processor 504 shown in FIG. 2 and FIG. 5. The exemplary means 700 may include means 708 for outputting a frame for transmission. Means 708 may include, for example, an interface (e.g., of a processor), antennas 224, antennas 252, transmitter units 222, transmitter units 254, TX spatial processor 220, TX spatial processors 290, TX data processor 210, TX data processors 288, controller 230, controllers 280, antennas 516, transmitter 510, digital signal processor 520, and/or processor 504 shown in FIG. 2 and FIG. 5. The exemplary means 700 may include means 710 for obtaining feedback based on the outputted frame. Means 710 may include, for example, antennas 224, antennas 252, receiver units 222, receiver units 254, RX spatial processor 240, RX spatial processors 260, RX data processor 242, RX data processors 270, controller 230, controllers 280, antennas 516, receiver 512, digital signal processor 520, and/or processor 504 shown in FIG. 2 and FIG. 5. The exemplary means 700 may include means 712 for updating, based on the obtained feedback, PER information. Means 712 may include, for example, receiver units 222, receiver units 254, RX spatial processor 240, RX spatial processors 260, RX data processor 242, RX data processors 270, controller 230, controllers 280, antennas 516, receiver 512, digital signal processor 520, and/or processor 504 shown in FIG. 2 and FIG. 5. The exemplary means 700 may include means 714 for adjusting a scheduler probing period based on the obtained feedback. Means 714 may include, for example, transmitter units 222, transmitter units 254, TX spatial processor 220, TX spatial processors 290, TX data processor 210, TX data processors 288, controller 230, controllers 280, antennas 516, transmitter 510, digital signal processor 520, and/or processor 504 shown in FIG. 2 and FIG. 5. The exemplary means 700 may include means 714 for determining a transmission mode for transmitting data by calculating a set of scoring metrics associated with one or more transmission modes and by selecting the transmission mode with a highest scoring metric for throughput within the set of scoring metrics. Means 714 may include, for example, transmitter units 222, transmitter units 254, TX spatial processor 220, TX spatial processors 290, TX data processor 210, TX data processors 288, controller 230, controllers 280, antennas 516, transmitter 510, digital signal processor 520, and/or processor 504 shown in FIG. 2 and FIG. 5.

The various operations of methods described above may be performed by any suitable means capable of performing the operations. The means may include various hardware and/or software component(s) and/or module(s), including, but not limited to a circuit, an application specific integrated circuit (ASIC), or processor. Generally, any operations illustrated in the Figures may be performed by corresponding functional means capable of performing the operations.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term receiver may refer to an RF receiver (e.g., of an RF front end) or an interface (e.g., of a processor) for receiving structures processed by an RF front end (e.g., via a bus). Similarly, the term transmitter may refer to an RF transmitter of an RF front end or an interface (e.g., of a processor) for outputting structures to an RF front end for transmission (e.g., via a bus).

As used herein, a phrase referring to “at least one of” a list of items refers to any combination of those items, including single members. As an example, “at least one of: a, b, or c” is intended to cover a, b, c, a-b, a-c, b-c, and a-b-c, and also a-a, b-b, and c-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication, comprising:
a processing system configured to:
determine whether to initiate scheduler probing based on a condition; and
perform scheduler probing by:
determining whether single-user (SU) mode will be used; and
determining a set of transmission parameters based on the determination of whether SU mode will be used; and
an interface configured to, if the scheduler probing is initiated, output a frame for transmission based on the set of transmission parameters.

2. The apparatus of claim 1, wherein the processing system is configured to determine whether to initiate scheduler probing by performing at least one of:
determining a multi-user (MU) modulation and coding scheme (MCS);
determining a SU MCS; or
determining whether a scheduler probing period has expired, wherein the condition is one of the determined MU MCS being less than or equal to a first threshold, the determined SU MCS being greater than or equal to a second threshold, or the scheduler probing period having expired.

3. The apparatus of claim 1, wherein the determination of whether SU mode will be used is based on a previously probed transmission mode or a previously probed modulation and coding scheme (MCS).

4. The apparatus of claim 3, wherein the processing system is configured to determine whether SU mode will be used by performing one of:
determining to probe down to the SU mode from a multi-user (MU) mode, wherein the previously probed transmission mode is the MU mode;
determining to probe down from a current MU mode to a lower order MU mode, wherein the previously probed transmission mode is the current MU mode;
determining to probe up from the SU mode to the MU mode, wherein the previously probed transmission mode is the SU mode; or
determining to probe up from the current MU mode to a higher order MU mode, wherein the previously probed transmission mode is the current MU mode.

5. The apparatus of claim 1, wherein the processing system is configured to determine the set of transmission parameters by:
determining at least one of a modulation and coding scheme (MCS), a number of spatial streams, or a bandwidth to use for transmitting the frame for scheduler probing; and
determining a number of data units to transmit within the frame for scheduler probing.

6. The apparatus of claim 1, wherein the interface is further configured to obtain feedback based on the outputted frame, wherein the processing system is further configured to update, based on the obtained feedback, packet error rate (PER) information corresponding to the set of transmission parameters.

7. The apparatus of claim 6, wherein the processing system is further configured to adjust a scheduler probing period based on the obtained feedback, wherein the scheduler probing is performed based on the adjusted scheduler probing period.

8. The apparatus of claim 1, wherein the processing system is configured to determine whether SU mode will be used by:
calculating a set of scoring metrics associated with one or more transmission modes; and
selecting the transmission mode associated with a highest scoring metric for throughput within the set of scoring metrics.

9. The apparatus of claim 8, wherein each scoring metric in the set of scoring metrics is a throughput measurement associated with a particular transmission mode, and each scoring metric is calculated based on a total transmission airtime and a total amount of data to be transmitted for each user of a number of devices associated with the particular transmission mode.

10. A method of wireless communication, comprising:
determining whether to initiate scheduler probing based on a condition;
performing scheduler probing by:
determining whether single-user (SU) mode will be used; and
determining a set of transmission parameters based on the determination of whether SU mode will be used; and
outputting a frame for transmission based on the set of transmission parameters if the scheduler probing is initiated.

11. The method of claim 10, wherein the determining whether to initiate scheduler probing comprises at least one of:
determining a multi-user (MU) modulation and coding scheme (MCS);
determining a SU MCS; or
determining whether a scheduler probing period has expired, wherein the condition is one of the determined MU MCS being less than or equal to a first threshold, the determined SU MCS being greater than or equal to a second threshold, or the scheduler probing period having expired.

12. The method of claim 10, wherein the determination of whether to SU mode will be used is based on a previously probed transmission mode or a previously probed modulation and coding scheme (MCS).

13. The method of claim 12, wherein the determining whether SU mode will be used comprises:
determining to probe down to the SU mode from a multi-user (MU) mode, wherein the previously probed transmission mode is the MU mode;
determining to probe down from a current MU mode to a lower order MU mode, wherein the previously probed transmission mode is the current MU mode;
determining to probe up from the SU mode to the MU mode, wherein the previously probed transmission mode is the SU mode; or
determining to probe up from the current MU mode to a higher order MU mode, wherein the previously probed transmission mode is the current MU mode.

14. The method of claim 10, wherein the determining the set of transmission parameters comprises:
determining at least one of a modulation and coding scheme (MCS), a number of spatial streams, or a bandwidth to use for transmitting the frame for scheduler probing; and
determining a number of data units to transmit within the frame for scheduler probing.

15. The method of claim 10, further comprising:
obtaining feedback based on the outputted frame; and
updating, based on the obtained feedback, packet error rate (PER) information corresponding to the set of transmission parameters.

16. The method of claim 15, further comprising adjusting a scheduler probing period based on the obtained feedback, wherein the scheduler probing is performed based on the adjusted scheduler probing period.

17. The method of claim 10, wherein the determining whether SU mode will be used comprises:
calculating a set of scoring metrics associated with one or more transmission modes; and
selecting the transmission mode associated with a highest scoring metric for throughput within the set of scoring metrics.

18. The method of claim 17, wherein each scoring metric in the set of scoring metrics is a throughput measurement associated with a particular transmission mode, and each scoring metric is calculated based on a total transmission airtime and a total amount of data to be transmitted for each user of a number of devices associated with the particular transmission mode.

19.-28. (canceled)

29. A wireless node for wireless communication, comprising:
a processing system configured to:
determine whether to initiate scheduler probing based on a condition; and
perform scheduler probing by:
determining whether single-user (SU) mode will be used; and
determining a set of transmission parameters based on the determination of whether SU mode will be used; and
a transmitter configured to, if the scheduler probing is initiated, output a frame for transmission based on the set of transmission parameters.
